(19) United States
(12) Patent Application Publication
(10) Pub. No.: US 2026/0261485 A1
(43) Pub. Date: Sep. 3, 2026

(54) PREDICTIVE CONFLICT MANAGEMENT

(71) Applicant: LENOVO (SINGAPORE) PTE. LTD., Singapore (SG)

(72) Inventors: Emmanouil Pateromichelakis, Viersen (DE); Konstantinos Samdanis, Munich (DE); Dimitrios Karampatsis, Ruislip (GB)

(73) Assignee: Lenovo (Singapore) Pte. Limited, Singapore (SG)

(21) Appl. No.: 19/491,206

(22) PCT Filed: Jul. 4, 2023
(86) PCT No.: PCT/EP2023/068399

§ 371 Date: Dec. 8, 2025

(30) Foreign Application Priority Data
Jun. 15, 2023 (GR) 20230100480

(51) Int. Cl. H04L 41/147; H04L 41/0823; H04L 41/0873; H04L 41/14; H04W 24/06

(52) U.S. Cl. CPC H04L 41/147; H04L 41/0823; H04L 41/0873; H04L 41/145; H04W 24/06

(57) ABSTRACT

A network entity comprises a transceiver and processing circuitry configured to obtain a simulation model of a radio access network, the simulation model being configurable using one or more parameters to simulate operation of the radio access network, receive a network configuration requirement for the radio access network, wherein the network configuration requirement is applicable to a first network automation application and configure said one or more parameters of the simulation model based on the network configuration requirement and a network configuration requirement applicable to at least one other second network automation application. The entity is further configured to perform a simulation of operations of the radio access network using the simulation model with the updated one or more parameters and predict any potential conflicts that arise as a result of the network configuration requirements.

### TECHNICAL FIELD

The present application relates to configuring a radio access network.

### BACKGROUND

A wireless communications system may include one or multiple network communications devices. For radio communications networks beyond the 5G era, the notion of a “system” will consist of multiple segments, and will see the traditional network as a pipe consisting of commodity hardware and/or software. This system may comprise Radio Access Networks (RAN), Transport Network (TN), Core Network (CN) as well as the edge cloud/cloud/application enablement domains for the e2e User Plane path, whereas the control and management plane can be unified and will consist of virtualized services which will be deployed within the access and core network domains and will be able to be exposed to the vertical customer, to allow the customer to optimize the end to end service it offers to its subscribers.

The players involved in this system will also increase, and stakeholders involved at developing/producing the platform capabilities within this extended system and may span at the vertical domain, the edge/regional/core cloud provider domain, and Application Program Interface (API) and Software Development Kit (SDK) 3rd party providers.

In such an extension of the system, the set of potential problems will be extended too, and problems related to edge/cloud resource management and control, selecting the best data network (DN) for the application, application portability/migration aspects, and extension of slicing to cover the edge/vertical cloud components, trusted application-to-application interactions, etc. will arise.

One challenge that arises in such a system is the need for testing and verifying new services that span different domains and for evaluating the impact that such services have on the various parts of the system. Pro-active monitoring of events related to different parts of the system (device, RAN, TN, CN, edge DN, DN, middleware) may help address some problems. However it may add significant complexity to the different stakeholders and may involve a level of coordination as well as negotiations between the stakeholders involved. Furthermore, the vertical customer may benefit from extensive testing before using 5G access for critical operations and may also benefit from backup access networks being available for critical services.

One possible issue in the case of multiple telecommunications services which are provided by different stakeholders (e.g. Mobile Network Operator (MNO), Edge Computing Service Provider (ECSP), Application Service Provider (ASP)) and exposed at a finer granularity (e.g. as microservices) is the fact that possible conflicts may occur since one or more telecommunications services may affect the same telecommunications resources. Telecommunications resources are defined here as either radio resources, network resources, Quality of Service (QoS) profiles, management resources, or slice resources or computational resources at the telecommunications edge or cloud.

A conflict can be expected to happen either directly or indirectly or implicitly when two or more consumers perform network API invocations to request use of the same telecommunications resources. [Here the term “consumer” is used to identify a consumer or resources and/or services within the network and does not refer to an end user, e.g. a User Equipment.] This may arise when two or more consumers request the same telecommunications service, or when two or more consumers request different telecommunications services which may share some dependencies with respect to the affected telecommunications resources.

Open RAN or O-RAN Reference Architecture is a non-proprietary version of the Radio Access Network (RAN) system that allows interoperation between cellular network equipment provided by different vendors. It is designed with the principles of intelligence and openness; the O-RAN architecture is the foundation for building a virtualized RAN on open hardware with embedded Al-powered radio control.

An O-RAN may employ a RAN Intelligent Controller (RIC). A RIC may be provided as a software defined component of the O-RAN. The RIC may provide recommendations for optimization of the network. The RIC may be divided into non-real time (non-RT) and near-real time (near-RT) components. The non-RT RIC uses applications known as rApps to control the resources of the RAN. The near-RT RIC uses applications known as xApps to control the resources of the RAN in near-real time. A service producer may employ one or more xApps to configure the network. An xApp is a software tool that may be employed by a RIC to perform near-real time management of functions of the network. For example, an xApp may perform a Traffic Steering Optimization operation, Quality of Service optimization operation, or a Quality of Experience optimization operation. Also, an xApp can provide further Radio Resource Management (RRM) and Self Organized Network (SON) algorithms and policies related to the underlying radio access network and the constituent devices.

Both xApps and rApps can be seen as network automation applications, which can be deployed by the RIC platform provider or by an external third party stakeholder (e.g. vertical, Original Equipment Manufacturer (OEM)).

FIG. 1 illustrates a configuration of an O-RAN 1 comprising a RIC (platform) 2. The RIC 2 controls various network resources including radio resources such as E2 Nodes 3, Service Management and Organisation (SMO) resources 4; and third party resources from third party service providers 5, such as multi-access edge computing (MEC). The illustrated RIC 2 employs three xApps: xApp1 6a; xApp2 6b; and xApp3 6c, to control and manage the available resources. For example, xApp1 6a may be a traffic steering optimisation application, xApp2 6b may be a Quality of Service (QoS) optimisation application, and xApp3 6c may be a RAN analytics application.

In such a system for providing telecommunications resources, conflict management is a task of significant importance since the RIC service needs to accommodate requests from multiple consumers in a timely manner (according to Service Level Agreements (SLA)). As shown in FIG. 1, the RIC may comprise a Conflict Management Unit 4 to manage potential conflicts in the O-RAN 1.

There are a number of situations where conflicts may arise. For example, diverse xApps (e.g. a Traffic Steering optimization xApp and a QoS optimization xApp) which may originate from different Original Equipment Manufacturers (OEMs), service providers, or ASPs, may request the same radio resource. In another example an xApp may request updates on a radio resource that will impact UEs or RAN performance and may affect the optimization targets of other xApps. There can be different ways to address this problem. However the impacts to the system and Key Performance Indicator (KPI) fulfilment (e.g. performance changing in cell area and all UEs running different services) are difficult to evaluate in advance.

It is desirable to enhance current network architecture to support efficient conflict management and to improve the O-RAN's ability to fulfil service agreements when multiple stakeholders are involved. This may involve extensive and sophisticated use case analysis and what-if scenario testing based on customer needs. Such analysis and testing may increase the complexity of the system since it may involve real time measurements and simulating different environments continuously so as to allow sufficient testing of the expected performance and capturing worst-case scenarios.

A problem to be addressed is how to efficiently resolve potential resource conflicts which may be caused by different network and/or service capability exposure requirements from different third party consumers. In particular, a problem to be addressed is how to ensure the capability exposure requirements of different consumers with similar requests are fulfilled.

In the O-RAN ecosystem, multiple use cases have been proposed as possible scenarios where O-RAN, and in particular Artificial Intelligence (AI)-assisted network optimization, can be beneficial. These include General RAN Optimization Use cases (e.g. traffic Steering: user-centric AI-enabled traffic steering to switching among air interfaces (e.g. sub-6 GHz, mmWave), predictive Quality of Experience (QoE)/QoS optimization, and massive multi-input and multi-output (MIMO) optimization.

There may also be use cases where network optimization is beneficial for various vertical markets such as: the Automotive industry, such as in Vehicular to Everything (V2X) systems, e.g., Context Based Dynamic Handover Management for V2X; Unmanned Aerial Systems (UAVs), such as in Flight Path Based Radio Resource Allocation for UAV Applications; and the Industrial Internet of Things (IIoT). There may also be uses in provision of service level agreements such as in RAN slice assurance.

In such use cases, Radio Resource Management (RRM) or Self-Organizing Network (SON) algorithms can operate at third party applications and aim to optimize UE and RAN performance with the assistance of big data analytics for clusters of O-RAN cells.

Still, these use cases require real-time data and events from the RAN and/or one or a plurality of UEs and, in realistic scenarios, it is overly complex to have all measurements provided to a RAN controller which serves numerous cells. Also, one key challenge is to appropriately configure the network when there are conflicts in requests that target the same resources. An O-RAN Radio Intelligent Controller may include a Conflict Mitigation module to address such problems. However there can be various possible conflicts that arise in such a system and resolution of these conflicts is a difficult task.

The O-RAN Reference Architecture provides next generation RRM with embedded intelligence, while optionally accommodating legacy RRM. The RRM resides within a RIC Near RT function layer. The RIC near-RT is completely compatible with legacy the RRM, and is designed to enhance operationally challenging functions such as per-UE controlled load-balancing, Radio Bearer (RB) management, interference detection and mitigation.

In the context of Near-RT RIC, conflict mitigation refers to addressing conflicting interactions between different xApps. An application will typically change one or more parameters in the network with the objective of optimizing a specific metric. Conflict mitigation is used because xApps' objectives may be chosen or configured such that they result in conflicting actions.

The control target of the RRM can be a cell, a UE or a bearer, etc. The control contents of the RRM can cover access control, bearer control, handover control, QoS control, resource assignment and so on. The control time span indicates the valid control duration which is expected by the control request. The types of conflicts that can arise are described below.
1) Direct Conflicts:

Direct conflicts can be observed directly by a Conflict Mitigation Unit (CMU). Some examples are described as below:
Two or more xApps request different settings for one or more parameters of a Control Target. The CMU processes the requests and decides on a resolution.
A new request from an xApp may conflict with the running configuration resulting from a previous request of another or the same xApp.
The total requested resources from different xApps may exceed the limitation of the RAN system, e.g. the sum of resources required by two different xApps may be beyond the resource limitation of the RAN system.
2) Indirect Conflicts:

Indirect conflicts cannot be observed directly. Nevertheless, some dependence among the parameters and resources that the xApps target can be observed. The CMU may anticipate some of the possible conflicts and take actions to mitigate them. For instance, different xApps may target different configuration parameters to optimize the same metric according to the respective objective of each xApp. Even though this targeting of different configuration parameters may not result in conflicting parameter settings, it may have uncontrollable or inadvertent effects on the functioning of the system. One example of such an indirect conflict can occur when the changes required by one xApp create a system impact which is equivalent to a parameter change targeted by another xApp, e.g., antenna tilts and measurement offsets are different control points, but they both impact a handover boundary.
3) Implicit Conflicts

Implicit conflicts cannot be observed directly—even the dependences between various xApps are not obvious. For instance, different xApps may optimize different metrics and (re-)configure different network parameters. Nonetheless, optimizing one metric may have implicit, unwanted, and potentially adverse side effects on one of the metrics optimized by another xApp, e.g., protecting throughput metrics for Guaranteed Bit Rate (GBR) users may degrade non-GBR metrics or even cell throughput.

In order to mitigate these conflicts, different approaches exist:
1) Direct conflicts typically can be mitigated by pre-action coordination, i.e., an xApp or the CMU makes a final determination on whether any specific change is to be made, or in which order the changes are to be applied.
2) Indirect conflicts can be resolved by post-action verification. Here, the actions are executed and the effects on the target metric are observed. Based on the observations, the CMU may decide on potential corrections, e.g., rolling back one of the xApp actions.
3) Implicit conflicts are the most difficult to mitigate since these dependencies are difficult to observe and therefore hard to model in any mitigation scheme. In some cases, it may be possible to design around such conflicts by ensuring that different xApps target different parameters, thus falling back to approach 2), but preferably, a generic approach to managing such conflicts is established.

A problem to be solved by the present application is how to efficiently resolve in a RIC potential resource conflicts which may be caused by network/service capability exposure requirements from different third party applications (or xApps). In particular, a problem to be solved by the present application is how to ensure the capability exposure requirements of different xApps with similar requests are fulfilled.

### SUMMARY

According to a first aspect of the present invention there is provided a network entity comprising a transceiver and processing circuitry configured to obtain a simulation model of a radio access network, the simulation model being configurable using one or more parameters to simulate operation of the radio access network. The network entity receives a network configuration requirement for the radio access network, wherein the network configuration requirement is applicable to a first network automation application. The network entity configures said one or more parameters of the simulation model based on the network configuration requirement and a network configuration requirement applicable to at least one other second network automation application and performs a simulation of operations of the radio access network using the simulation model with the updated one or more parameters, and predicts any potential conflicts that arise as a result of the network configuration requirements.

According to a second aspect of the present invention there is provided a network entity comprising a transceiver and processing circuitry configured to receive a network configuration requirement for a radio access network, wherein the network configuration requirement is applicable to a first network automation application. The network entity sends a request to a further network entity to perform a simulation of operations of the radio access network based on the network configuration requirement and a network configuration requirement applicable to at least one other second network automation application. The network entity receives a result of the simulation from the further network entity, wherein the result of the simulation includes an indication identifying any potential conflicts that arise as a result of the network configuration requirements, and sends the result of the simulation to the first and/or second network automation application.

According to a third aspect of the present invention there is provided a computer-implemented method of predicting a conflict in a radio access network. The method comprises obtaining a simulation model of the radio access network, the simulation model being configurable using one or more parameters to simulate operation of the radio access network, receiving a network configuration requirement for the radio access network, wherein the network configuration requirement is applicable to a first network automation application, and updating said one or more parameters of the simulation model based on the network configuration requirement and a network configuration requirement applicable to at least one other second network automation application. The method further comprises performing a simulation of operations of the radio access network using the simulation model with the updated one or more parameters and identifying any potential conflicts that arise as a result of the network configuration requirements.

### BRIEF DESCRIPTION OF DRAWINGS

FIG. 1 depicts a general configuration of a state-of-the-art O-RAN;

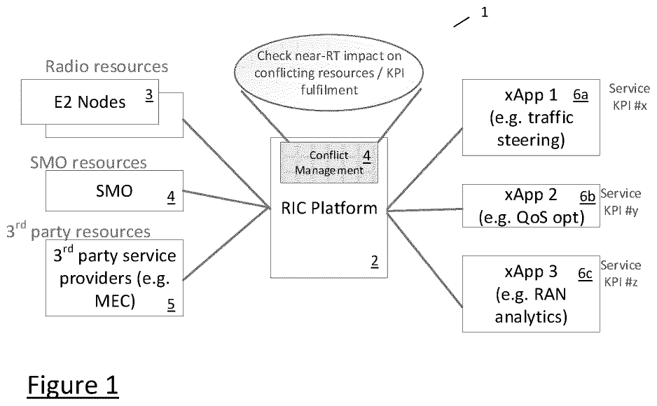

FIG. 2 depicts a detailed configuration of an O-RAN according to an embodiment;

FIG. 3 depicts an O-RAN and a Digital Twin;

FIG. 4 is a signalling diagram illustrating signalling according to an embodiment;

FIG. 5 is a signalling diagram illustrating signalling according to an embodiment;

FIG. 6 is a flowchart showing a method performed by a DTCU according to an embodiment;

FIG. 7 is a flowchart showing a method performed by a CMU according to an embodiment; and

FIG. 8 illustrates schematically an embodiment of a network entity.

### DETAILED DESCRIPTION

Proposed here is a mechanism for providing efficient and predictive conflict mitigation for explicit or implicit potential conflicts resulted from API invocations which target either the same resources (network or computational) or resources which may affect the performance of other resources due to dependencies. This is done using digital twins to allow the prediction of the expected conflicts to be based on extensive simulations which are not requiring real-time data but data produced at the digital twin based simulation environment. This mechanism is applicable to RAN exposure (introducing enhancements in RIC) as well as to 5G network service exposure.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

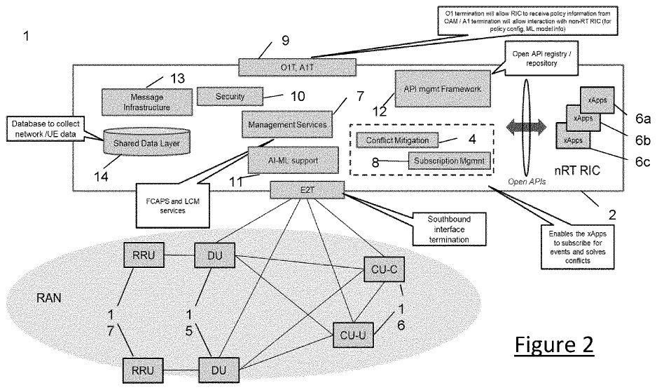

FIG. 2 is a diagram of an open radio access network (O-RAN) 1 according to an embodiment. The O-RAN 1 may provide a number of network services or functionalities. A network service may be one or more of an O-RAN near-real time RAN Intelligent Controller (RIC) function/service provided on a RIC platform 2, an O-RAN non-real time RAN Intelligent Controller (RIC) function/service provided on a non-real time RIC platform, an xApp service 6a, 6b, 6c, an rApp service, a management service 7, an API enablement service, a UE functionality, an Application Function (AF) service, a RAN function service, an E2 node service, a northbound API, a southbound API, and/or a Common API Framework (CAPIF) API. Other network services may also be provided in the O-RAN 1.

The near-real time RIC platform 2 comprises a Conflict Mitigation Unit (CMU) 4 which is responsible for predicting or detecting a conflict between requests from the various xApps 6a, 6b, 6c and deciding an action to resolve this. The RIC further comprises a Digital Twin Control Unit (DTCU)—not shown—which is responsible for configuring “what-if” scenarios and extracting simulation outputs based on the digital twin of the network element(s). This can be a logical entity which is co-deployed with the CMU. The DTCU may be part of the CMU or may be a separate entity. According to another embodiment, the DTCU is deployed as an xApp or an rApp.

A digital twin is a digital representation of a real-world entity or system. The implementation of a digital twin is an encapsulated software object or model that mirrors a unique physical object, process, organization, person or other abstraction. Data from multiple digital twins can be aggregated for a composite view across a number of real-world entities.

A digital twin of a network unit (e.g. RAN, Network Function (NF)), also known as a network twin, may run in the background of the O-RAN 1 and provide simulations, process data, and influence scheduling policies and/or O-RAN 1 behaviour. In particular, such simulations may be set under different service and network criteria (e.g. network load, service levels, different assumptions on the spectrum/deployment of functions etc).

The RIC further comprises a Subscription Management Unit 8. The Subscription Management Unit 8 is responsible for managing E2 node subscriptions from xApps 6a, 6b, 6c in the O-RAN 1. The Subscription Management Unit 8 may merge subscriptions from multiple xApps 6a, 6b, 6c internally. The Subscription Management Unit 8 may operate in conjunction with the CMU 4 to avoid conflicting subscriptions being applied to the O-RAN 1.

The RIC may further comprise an O1 interface Termination point (O1T), A1 interface Termination point (A1T) 9, a security module 10, an Artificial Intelligence/Machine Learning module 11, an API management framework module (aka API enablement module) 12, a message infrastructure module 13, and a shared data layer 14. The shared data layer 14 is used to store network and UE data. The API management framework 12 module may be an open API registry or repository. The management service module 7 may provide fault, configuration, accounting, performance and security (FCAPS) services and Local Congestion Mitigation (LCM) services.

The RIC architecture further specifies an open interface, namely an E2 interface, which is between the near-RT RIC (accessible via the E2 termination point) and Distributed Units (DUs) 15 and Centralized Units (CUs) 16 in the O-RAN 1.

The RIC may be configured to in turn configure the O-RAN. The O-RAN may further comprise a plurality of DUs 15, CUs 16, and Remote Radio Units (RRU) 17.

The O-RAN 1 may be integrated with a Telecommunications Service Producer (TSP)—not shown in FIG. 2—which can be a telecommunications network function at a Mobile Network Operator (MNO), Edge Computing Service Provider (ECSP) or Cloud Service Provider (CSP) side. The TSP may be comprise part of O-RAN 1 or may interwork with the O-RAN 1 via the xApps or rApps or via an SMO. For example, for Core services, a TSP can be a Network Function (NF) e. g a Network Data Analytics Function (NWDAF) which interacts with the O-RAN 1 as an external application, or for O-RAN services the TSP can be a function of the RIC or an xApp or a producer of the RIC service module.

The O-RAN further comprises a Telecommunications Service Consumer (TSC) which can be an entity (which can be external or internal to O-RAN) that may consume the network service provided by one or more TSPs.

In certain embodiments, the O-RAN further may comprise a Gateway (GW) entity which can be realized as a Network Exposure Function, Service Capability Exposure Function, Exposure Governance Management Function, Common API Framework API Exposure Function, edge platform or RIC platform GW. The GW entity may include a CMU and/or DTCU in certain implementations.

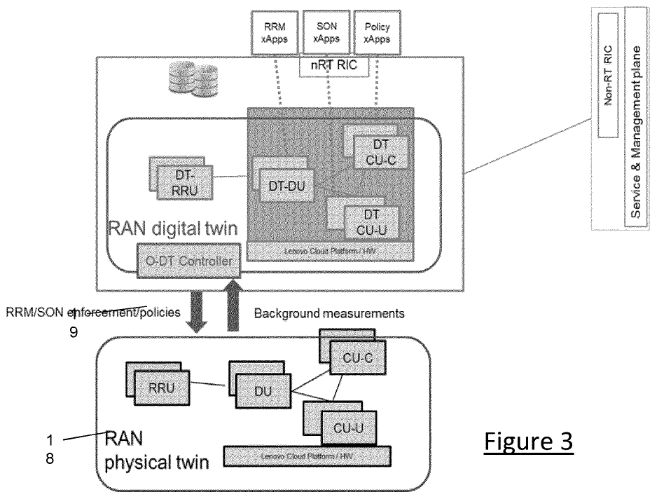

FIG. 3 is an example of a use of a Digital Twin 18 in an O-RAN 1 that may be generated in a DTCU. In FIG. 3, the RIC has exposure to three third party xApps which may optimize O-RAN parameters. The RIC can make use of big data analytics and can be deployed at an edge location. However, data may not be always accessible (especially from the UEs) and there are limitations in terms of latency (e.g., for real time data to be considered from E2 nodes). Data inputs may not be available for RAN analytics. An O-RAN digital twin 18 and in particular an O-RAN digital twin controller (O-DTC) module 19 in the near-RT platform may allow the RIC to make use of big data analytics for simulating all RAN related actions (e.g. what-if scenarios). The O-DTC creates a simulation framework in the near-RT RIC for data sample generation (for all hypothetical scenarios) and allows testing performance to be evaluated and can ensure that an O-RAN 1 cell cluster has guaranteed availability and performance.

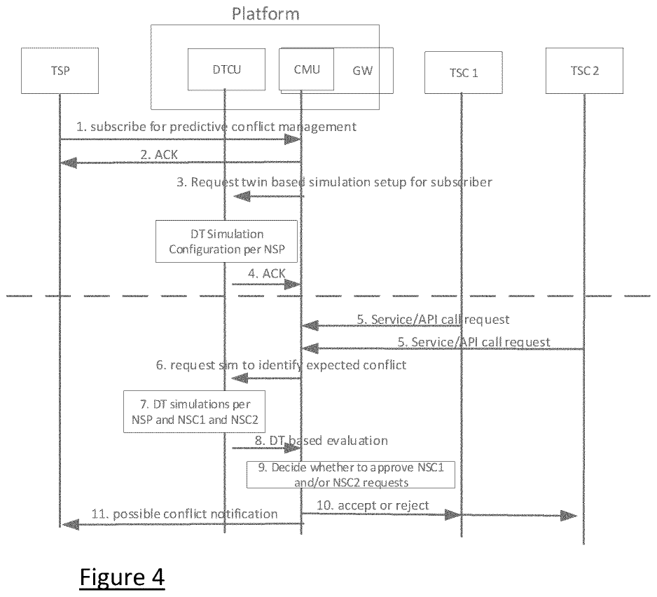

FIG. 4 is a signalling diagram illustrating signalling according to an embodiment and including the following signalling steps, S1 to S11.

In S1, the TSP sends a subscription request to the CMU to request predictive conflict mitigation services for a certain area of the O-RAN at a certain time for the network service which is offered. The subscription may be requested due to an expected high load or congestion on the network and/or a high number of API invocations in a target area due to an event. As part of the subscription request, the TSP provides details of any service level agreements as well as a profile of the service provided (e.g., coverage, spectrum preference).

In S2, the CMU sends an acknowledgement to the TSP.

In S3, the CMU sends a request to the DTCU to set up a simulation environment for the network service. In this setup, a number of different possible what-if scenarios are provided as well as the required configuration. One example parameter for the simulator can be the different UE densities, resource load, spectrum considerations, average number of API invocations, consumer KPIs, coverage area, dependent network entities. The DTCU then instantiates the digital twin of the network service and parameterizes the simulation environment.

In S4, the DTCU sends an acknowledgement to the CMU when the simulation setup is ready.

In S5, one or more Telecommunications Service Consumers (TSC) sends a service/API call request to the CMU/TSP via the GW/CMU.

In S6, the CMU sends a request to the DTCU to run a simulation of a whole or part of the O-RAN based on the service/API call requests, including a request for a simulation result on whether a conflict is predicted. The request may also include a request to, if a conflict is predicted, provide a possible recommendation to resolve the predicted conflict.

In S7, the DTCU provides this parameter (e.g., xApp #1 requests #x service, xApp #2 requests #y service) to the simulator (if a separate entity) and runs the simulation under different what-if scenarios. The DTCU identifies whether there are any possible conflicts where one or more TSCs' requests are fulfilled and, if there are any possible conflicts, indicates what action should be taken. The simulation may also provide a result on what the impact will be on the O-RAN if one request is rejected over another.

In S8, the DTCU sends an outcome (yes or no) and optionally the recommended action to the CMU.

In S9, the CMU decides to allow, reject, or negotiate the approval of the request(s) of the TSC(s) to access the requested service. If the CMU decides to negotiate the approval of the request, it may provide a counterproposal to the TSC, such as instructing retrying the API request at a later time or requesting use of another TSP which is less loaded.

In S10, the CMU notifies the TSC of the result, i.e. acceptance/rejection of the invocation request.

Ins S11, the CMU may also notify the TSP of a rejection of the request and optionally a cause of the rejection, or may notify the TSP of a confirmation of the request.

The following embodiments are described wherein the RIC is a near-real time RIC. However, according to other embodiments, the RIC is a non-real time RIC architecture where the xApps are replaced with rApps, and the network optimization tasks relate to non-real time tasks such as Load Balancing and Energy Saving optimization. In such embodiments, the CMU is not present in the RIC but equivalent functions are performed as part of the non-real time framework.

### First Embodiment—ORAN RIC DTCU Configuration Simulation

A first embodiment describes the configuration of a digital twin-based simulation entity based on the TSP requirements. According to this embodiment, the mechanism focuses on providing parameters at the simulation environment for the twin-based simulations, based on the subscription of the TSP (O-RAN provider) that wants to set up the simulations for a particular use case. A use case in this context can be a Traffic Steering Optimization use case or a QoS optimization or energy-related optimization use case, or any O-RAN defined use case for xApp-driven optimizations.

According to a method of the first embodiment the following steps are performed:

The TSP sends a subscription/request to the CMU at the near-RT RIC for supporting a predictive conflict mitigation service for a given task (eg. an optimization task such as TS Opt) or a given resource (RAN resource, UE radio resource, radio bearer) or for a given area (cell area, cell cluster area).

Next, the CMU sends a response to the TSP which can be an acknowledgement, a negative acknowledgement, or a response indicating a result of the request.

Then, the CMU sends a request to the DTCU (if the DTCU is a separate logical entity, otherwise this step can be omitted) to request set up of the simulation environment and configurations of the expected simulations to be implemented. Such a request can be per subscriber and may indicate: the subscriber/task or resource identifier, the expected radio parameters (resource pools, Data Radio Bearers, L1/L2 parameters, Radio Resource Control parameters/timers, expected UE density, BS density, cell clustering info, computational resource info, KPIs/SLAs)

In a next step, the DTCU creates one or more digital twin-based simulations. In particular, the DTCU:
Instantiates a virtual representation of all expected entities (UEs, RAN functions, resources, objects) as digital twins (if not instantiated before).
Creates an aggregate of the digital twins based on the set of instantiated twins which are relevant for the subscriber. An example digital twin aggregate (also referred as DTA) for a subscriber #x may comprise: 1 CU, 2 DUs, 10 UEs, 100 RB groups, mobility parameter, list of flows/sessions, and a list of Data Radio Bearers (DRBs).
Determines a mapping of the digital twin aggregate to a set of RAN/UE related parameters based on the previous step. Such a mapping can be for example the linkage of the CU/DU functions and RIC functions to radio access configurations which can be allowed for the TSP based on its subscription (e.g. mmWave access vs sub-6 Gz access parameterization for the given network service of the TSP). For example: in a sport or music stadium event, the TSP is the stadium provider and the DTCU belongs to the O-RAN operator: in this case, based on the SLA for service coverage, the operator creates a digital twin aggregate, and the stadium provider parameterizes the simulation environment with parameters which are translated from the SLA and subscriptions to O-RAN services.
Determines the simulation tools/environment based on the mapping (like a book of assumptions for system level simulations). This determination is based on the mapping of the aggregate to parameters and may also configure the computational resources used for the simulations at the platform and determine if inputs are needed also from third party providers. Also, it may indicate possible inputs required for dynamic environment changes for the network elements.
In certain embodiments, if the simulations are expected to be exposed as a service to a third party consumer CMU (e.g. the CMU is an external application to the RIC), the DTCU configures an SDK including the tools/libraries and the APIs for the digital twin-based simulation exposure to the CMU to allow the CMU to independently run the simulations. Such exposure can be provided via RIC APIs with or without the support of the GW, and may be different based on the type of the consumer (for example different granularities and simulation setups may be exposed based on the use case and the type of the consumer).

Next, the DTCU informs the CMU, and optionally the digital twin SDK, that the digital-twin based simulation setup is ready.

### Second Embodiment—Implementation for O-RAN Near-RT RIC Platform

A second embodiment describes a run-time operation phase for managing conflicts in a RIC in a predictive manner, using network twins.

According to the second embodiment, a method is provided for the case in which the DTCU is an xApp or RIC function (it can be either of these depending upon the implementation), or an rApp, the CMU is an existing RIC function, the TSC is an xApp/third party app that wants to invoke RIC APIs, and the TSP is the O-RAN function provider (e.g. an E2 node which is equivalent to a RAN node/Base Station (BS)).

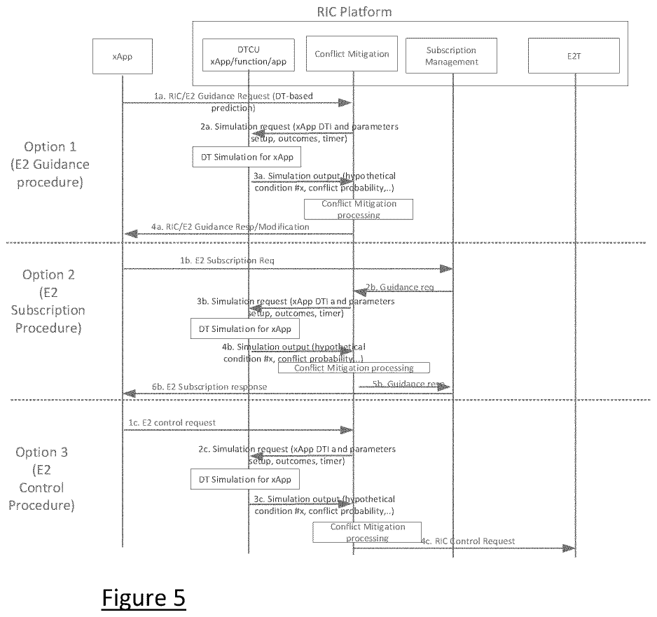

There are different existing procedures which are impacted in O-RAN RIC architecture specifications. FIG. 5 illustrates a signalling diagram illustrating signalling associated with three different procedures that can be applied according to the second embodiment.

Option 1—E2 guidance: The purpose of an xApp initiated E2 Guidance request API procedure in the Near-RT RIC is to allow an authorized xApp to obtain guidance from the CMU prior to initiating an action. The xApp may use an E2 Related API to obtain guidance from the CMU to resolve potential conflicts prior to initiating a RIC function procedure. In this procedure, the consumption of the DTCU services away from the CMU functionality allows for predictive conflict mitigation using digital twins as guidance. In Option 1, the goal of the procedure is to provide xApp initiation of Conflict Mitigation guidance.

The xApp is the originator of a Conflict Mitigation guidance request, and the procedure also includes utilising: a Near-RT RIC platform; a database; a CMU; and a DTCU (which may be implemented as an xApp). The procedure works on the assumption that the CMU has access to sufficient information to both detect a potential conflict and take a decision on an optimal mitigation solution, and that the CMU may initiate guidance towards other Platform Functions and/or xApps as an additional response to the Guidance Request.

According to the embodiment, the xApp is authorized to request guidance from the CMU and the xApp is assigned xApp ID. The Conflict Mitigation guidance request may include a network configuration requirement, such as a request for a network automation application to perform an optimisation task for a user equipment associated radio resource; a request for a network automation application to perform an optimisation task for a radio access network resource, a request for a network automation application to use a given radio network resource; a request for a network automation application to modify a given radio network resource, a request for a network automation application to provide a policy over a given radio network resource, and a request for a network automation application to operate in a given area of the radio access network.

The procedure begins when the xApp determines that it would be beneficial to request guidance from the CMU. In S1a, the xApp sends an E2 Related API E2 Guidance Request to the CMU. This request may include a request for predictive conflict mitigation using digital twin based simulations. This request may also indicate the hypothetical scenarios to be covered. Hypothetical communication parameters may be provided. The one or more hypothetical communication parameters may include one or more of: a user equipment density; user equipment distribution, a resource load; spectrum information; radio resource control parameters, radio resource management related parameters, average number of Application Programming Interface invocations; consumer key performance indicators; coverage area; and dependent network entities.

In S2a, the CMU sends a request to the DTCU to run the simulation for the given request. This request may include simulation parameters, the xApp name or IDs for which this guidance applies, the expected outputs and timing/area validity.

In S3a, the DTCU runs the simulations for all what-if scenarios (e.g. high load vs medium load at the target area and time, access limitations, HO failures etc), and generates simulation outputs for each scenario. As part of the outputs, the probability of conflict or a distribution over time and area may be generated as well as a yes/no result and possibly a recommendation for resolving a conflict. The DTCU then sends the simulation outputs of step 3a to the CMU.

In S4a, the CMU processes the xApp request using the simulation output and sends a result to the xApp.

In optional additional steps, the CMU may signal conflict and/or provide guidance to another xApp using E2 Related API E2 Guidance, and the CMU may send an E2 Related API E2 Guidance response to the another xApp.

As a result, the xApp continues processing using the guidance response.

Option 2—E2 Subscription (also applies to RIC Subscription): The purpose of the E2 Subscription procedure in the Near-RT RIC is to enable an xApp to request subscriptions for REPORT, INSERT and/or POLICY service(s) from the E2 interface, and to ensure that only validated and non-duplicate subscriptions are maintained by the Near-RT RIC over the E2 interface to the E2 Node and that duplicated E2 Subscription Request messages from xApps are handled appropriately. In this procedure, the xApp may obtain guidance from the Near-RT RIC Platform (i.e. the CMU) to resolve potential conflicts and/or detect partial duplications prior to sending a E2 Subscription Request. In this procedure, the consumption of the DTCU services from the CMU allow for predictive conflict mitigation using digital twins.

In S1b, the xApp sends an E2 Subscription Request to the xApp Subscription Management Unit. This request may include a request for predictive conflict mitigation using digital twin based simulations. This request may also indicate the hypothetical scenarios to be covered.

In S2b, the xApp Subscription Management Unit sends a guidance request to the CMU, and accepts or rejects the proposal from the xApp for use of a specific E2 Node. This request may include a request for predictive conflict mitigation using digital twin based simulations. This request may also indicate the hypothetical scenarios to be covered.

In S3b, the CMU sends a request to the DTCU to run a simulation for the given request. This request may include simulation parameters, the xApp name or IDs for which this guidance applies, the expected outputs and timing/area validity.

In S4b, the DTCU runs the simulations for all what-if scenarios (e.g. high load vs medium load at the target area and time, access limitations, HO failures etc), and generates simulation outputs for each scenario. As part of the outputs, the probability of conflict or a distribution over time and area may be generated as well as a yes/no result and possibly a recommendation for resolving a conflict. The DTCU then sends the simulation outputs of step 4b to the CMU.

In S5b, the CMU sends a Guidance response to the xApp subscription management unit, optionally indicating that the result is based on digital-twin based simulations, and including a conflict probability associated with a given scenario. This may also include a confidence level on the prediction and the prediction method used (Artificial Intelligence/Machine Learning type used).

In S6b, the xApp Subscription Management Unit sends the E2 related API: E2 Subscription response to xApp.

Option 3—E2 Control: The purpose of the E2 Control procedure in the Near-RT RIC is to ensure that only an authorized xApp may initiate RIC Control Request messages issued by the Near-RT RIC over the E2 interface to the E2 Node. The xApp may obtain guidance from the CMU to resolve potential conflicts prior to sending an E2 Control Request, or the E2 related API may be configured to route the E2 Control Request messages for an E2 node from the xApp either towards the CMU for acceptance or directly towards an appropriate E2 Termination instance. In this procedure, the consumption of the DTCU services from the CMU allows for predictive conflict mitigation using digital twins in the control procedure.

In S1c, an xApp sends an E2 related API: E2 Control request with message contents (RAN Function ID, Call process ID, Control Header, Control message) for a E2 Node, to the CMU. This request may include a requirement for predictive conflict mitigation using digital twin based simulations. This request may also indicate the hypothetical scenarios to be covered.

In S2c, the CMU sends a request to the DTCU to run a simulation for the given request. This request may include simulation parameters, the xApp name or IDs for which this guidance applies, the expected outputs and timing/area validity.

In S3c, the DTCU runs the simulations for all what-if scenarios (e.g. high load vs medium load at the target area and time, access limitations, HO failures etc), and generates simulation outputs for each scenario. As part of the outputs, the probability of conflict or a distribution over time and area may be generated as well as a yes/no result and possibly a recommendation for resolving a conflict. The DTCU then sends the simulation outputs of step 3c to the CMU.

In S4c, the CMU, after processing the simulation outputs, sends an RIC control message to the E2 Terminator, and the E2 Terminator sends an RIC Control Request (RIC Request ID, contents) to the E2 Node.

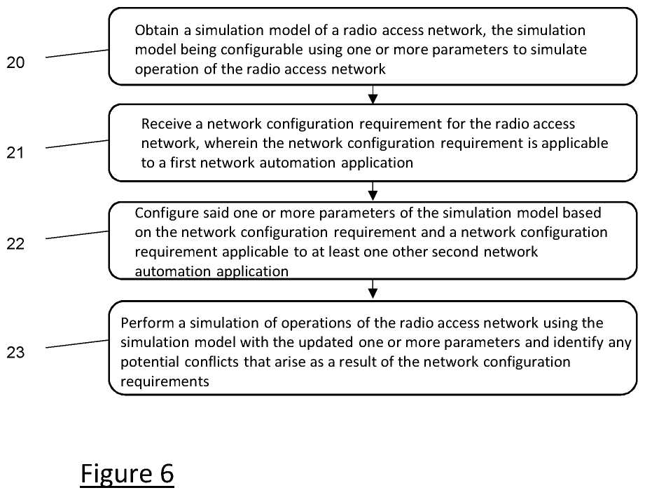

A method performed by the DTCU according to an embodiment is described with reference to FIG. 6.

A network entity, e.g. the DTCU, comprises a transceiver and processing circuitry. The network entity is configured to perform the following method steps.

In step 20, the DTCU obtains a simulation model of a radio access network, the simulation model being configurable using one or more parameters to simulate operation of the radio access network. The simulation model may be provided from an external source, or may be generated by the DTCU.

In step 21, the DTCU receives a network configuration requirement for the radio access network relating to a first network automation application. The network configuration requirement may be received from the CMU. The network requirement may be a trigger from the CMU to perform a simulation based on a network requirement received at the CMU from an xApp or other network automation application.

In step 22, the DTCU configures said one or more parameters of the simulation model based on the network configuration requirement and a network configuration requirement of at least one other second network automation application, e.g. another xApp.

In step 23, the DTCU performs a simulation of operations of the radio access network using the simulation model with the updated one or more parameters and identifies any potential conflicts that arise as a result of the network configuration requirements. Identifying any potential conflicts may comprise predicting that a conflict will occur.

The simulation model may be configurable using one or more parameters from one or more digital twins of radio access network constituent(s). A radio access network constituent may comprise a radio access network parameter, a network function and network protocol, network operation, a spectrum parameter, central unit, a distributed unit, a RIC, or a combination thereof.

Predicting any potential conflict may comprise indicating at least one parameter of an expectation of conflict, a probability of conflict, a time of conflict occurrence, an area of conflict occurrence, and a type of conflict applicable to the first and/or second network automation application.

The network entity may be at least one of an xApp, an rApp, a Radio Access Network Intelligent Controller, RIC, platform entity, a radio access network entity, a Service Management and Orchestration, SMO, entity.

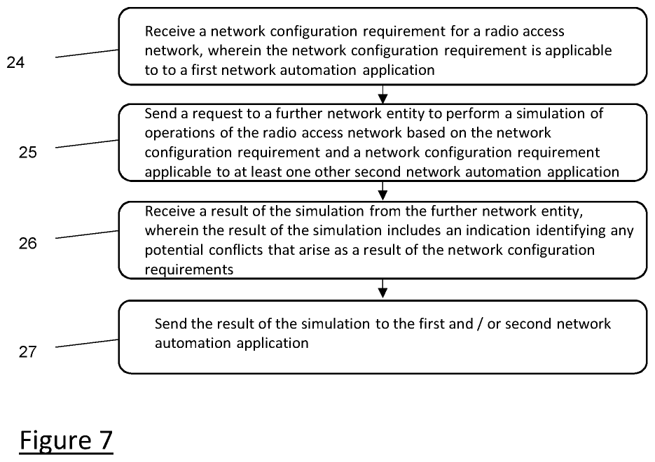

A method performed by the CMU according to an embodiment is described with reference to FIG. 7.

A network entity, e.g. the CMU, comprises a transceiver and processing circuitry.

In step 24, the CMU receives a network configuration requirement for a radio access network relating to a first network automation application. The network configuration requirement may be received from an xApp or other network automation application.

In step 25, the CMU sends a request to a further network entity, e.g. the DTCU, to perform a simulation of operations of the radio access network based on the network configuration requirement and a network configuration requirement of at least one other second network automation application.

In step 26, the CMU receives a result of the simulation from the further network entity, wherein the result of the simulation includes an indication identifying any potential conflicts that arise as a result of the network configuration requirements.

In step 27, the CMU sends the result of the simulation to the first and/or second network automation application. The result may be sent to the xApp.

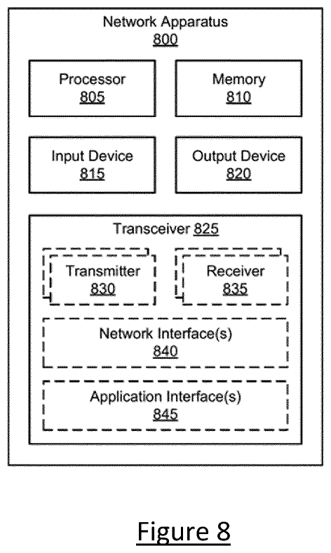

FIG. 8 depicts a network apparatus 800 that may be present within the core network and which may implement a DTCU and/or CMU according to embodiments The network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more UEs via one or more intermediate components. Additionally, the transceiver 825 may support at least one network interface 840 and/or application interface 845. The application interface(s) 845 may support one or more APIs.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

1. A network entity for wireless communication, comprising:
at least one memory; and
at least one processor coupled with the at least one memory and configured to cause the network entity to:
obtain a simulation model of a radio access network, the simulation model being configurable using one or more parameters to simulate operation of the radio access network;
receive a network configuration requirement for the radio access network, wherein the network configuration requirement is applicable to a first network automation application;
configure the one or more parameters of the simulation model based at least in part on the network configuration requirement and a network configuration requirement applicable to at least one second network automation application;
perform a simulation of operations of the radio access network using the simulation model configured with the one or more parameters; and
predict one or more potential conflicts that arise as a result of the network configuration requirements.

2. The network entity according to claim 1, wherein the at least one processor is further configured to cause the network entity to send a result of the simulation to a the first network automation application or the second network automation application, wherein the result of the simulation comprises the one or more potential conflicts.

3. The network entity according to claim 2, wherein the result of the simulation includes a recommended action to be taken by the first network automation application or the second network automation application.

4. The network entity according to claim 1, wherein the first network configuration requirement comprises at least one of: a request for the first network automation application to perform an optimization task for a user equipment associated radio resource; a request for the first network automation application to perform an optimization task for a radio access network resource; a request for the first network automation application to use a given radio network resource; a request for the first network automation application to modify a given radio network resource; a request for the first network automation application to provide a policy over a given radio network resource; or a request for the first network automation application to operate in a given area of the radio access network.

5. The network entity according to claim 1, wherein the network entity is at least one of an xApp, an rApp, radio access network intelligent controller (RIC), a platform entity, a radio access network entity, or a service management and orchestration (SMO) entity.

6. The network entity according to claim 1, wherein the simulation model comprises one or more hypothetical communication parameters.

7. The network entity according to claim 6, wherein the one or more hypothetical communication parameters include one or more of: a user equipment density; a user equipment distribution; a resource load; spectrum information; radio resource control parameters; radio resource management related parameters; an average number of application programming interface invocations; consumer key performance indicators; coverage area; or dependent network entities.

8. The network entity according to claim 1, wherein the simulation model is configurable using one or more parameters from one or more digital twins of at least one radio access network constituent.

9. The network entity according to claim 8, wherein each radio access network constituent comprises at least one of a radio access network parameter, a network function and a network protocol, a network operation, a spectrum parameter, a central unit, a distributed unit, or a radio access network intelligent controller (RIC).

10. The network entity according to claim 1, wherein to predict the one or more potential conflicts, the at least one processor is configured to cause the network entity to indicate at least one parameter of an expectation of conflict, a probability of conflict, a time of conflict occurrence, an area of conflict occurrence, or a type of conflict applicable to the network automation application or the second network automation application.

11. A network entity for wireless communication, comprising:
at least one memory; and
at least one processor coupled with the at least one memory and configured to cause the network entity to:
receive a network configuration requirement for a radio access network, wherein the network configuration requirement is applicable to a first network automation application;
send a request to a further network entity to perform a simulation of operations of the radio access network based at least in part on the network configuration requirement and a network configuration requirement applicable to at least one second network automation application;
receive a result of the simulation from the further network entity, wherein the result of the simulation includes an indication identifying one or more potential conflicts that arise as a result of the network configuration requirements; and
send the result of the simulation to the first network automation application or the second network automation application.

12. The network entity according to claim 11, wherein the network configuration requirement may be at least one of: a request for the first network automation application to perform an optimization task for a user equipment associated radio resource; a request for the first network automation application to perform an optimization task for a radio access network resource; a request for the first network automation application to use a given radio network resource; a request for the first network automation application to modify a given radio network resource; a request for the first network automation application to provide a policy over a given radio network resource; or a request for the first network automation application to operate in a given area of the radio access network.

13. The network entity according to claim 11, wherein the network entity is configured to approve or reject a configuration request from the first network automation application based at least in part on the result.

14. The network entity according to claim 11, wherein the at least one processor is further configured to cause the network entity to determine an action based at least in part on the result and send the action to the first network automation application or the second network automation application.

15. A method performed by a network entity, the method comprising:
obtaining a simulation model of a radio access network, the simulation model being configurable using one or more parameters to simulate operation of the radio access network;
receiving a network configuration requirement for the radio access network, wherein the network configuration requirement is applicable to a first network automation application;
updating the one or more parameters of the simulation model based at least in part on the network configuration requirement and a network configuration requirement applicable to at least one second network automation application;
performing a simulation of operations of the radio access network using the simulation model configured with the one or more parameters; and
identifying one or more potential conflicts that arise as a result of the network configuration requirements.

16. The method according to claim 15, wherein the first network configuration requirement comprises at least one of: a request for the first network automation application to perform an optimization task for a user equipment associated radio resource; a request for the first network automation application to perform an optimization task for a radio access network resource; a request for the first network automation application to use a given radio network resource; a request for the first network automation application to modify a given radio network resource; a request for the first network automation application to provide a policy over a given radio network resource; or a request for the first network automation application to operate in a given area of the radio access network.

17. The method according to claim 15, wherein the simulation model comprises one or more hypothetical communication parameters.

18. The method according to claim 17, wherein the one or more hypothetical communication parameters include one or more of: a user equipment density; a resource load; spectrum information; an average number of application programming interface invocations; consumer key performance indicators; coverage area; or dependent network entities.

19. (canceled)

20. (canceled)

21. A method performed by a network entity, the method comprising:
receiving a network configuration requirement for a radio access network, wherein the network configuration requirement is applicable to a first network automation application;
sending a request to a further network entity to perform a simulation of operations of the radio access network based at least in part on the network configuration requirement and a network configuration requirement applicable to at least one second network automation application;
receiving a result of the simulation from the further network entity, wherein the result of the simulation includes an indication identifying one or more potential conflicts that arise as a result of the network configuration requirements; and
sending the result of the simulation to the first network automation application or the second network automation application.

22. The method according to claim 21, wherein the network configuration requirement may be at least one of: a request for the first network automation application to perform an optimization task for a user equipment associated radio resource; a request for the first network automation application to perform an optimization task for a radio access network resource; a request for the first network automation application to use a given radio network resource; a request for the first network automation application to modify a given radio network resource; a request for the first network automation application to provide a policy over a given radio network resource; or a request for the first network automation application to operate in a given area of the radio access network.
